(19) United States
(12) Patent Application Publication
(10) Pub. No.: US 2014/0087651 A1
(43) Pub. Date: Mar. 27, 2014

(54) RELAY-BASED COMMUNICATION SYSTEM AND METHOD FOR SELECTING COMMUNICATION PATH

(71) Applicant: KOREA UNIVERSITY RESEARCH AND BUSINESS FOUNDATION, Seoul (KR)

(72) Inventors: Jun HEO, Seoul (KR); Jae-Young LEE, Seoul (KR)

(73) Assignee: KOREA UNIVERSITY RESEARCH AND BUSINESS FOUNDATION, Seoul (KR)

(21) Appl. No.: 14/092,190

(22) Filed: Nov. 27, 2013

Related U.S. Application Data
(63) Continuation of application No. PCT/KR2012/000647, filed on Jan. 30, 2012.

(30) Foreign Application Priority Data
May 27, 2011 (KR) 10-2011-0050797

(51) Int. Cl. H04W 40/16; H04B 7/14

(52) U.S. Cl. CPC H04W 40/16; H04B 7/14
USPC 455/7

(57) ABSTRACT

The present invention relates to a system and method for determining the optimal number of hops when transmitting information over a relay network. To this end, the present invention provides a method for determining a communication path through which at least one of a source node, a destination node, and at least one relay node between the source node and the destination node transmits information between the source node and the destination node in a relay network, the method comprising determining the optimal number of hops taking into account an interference signal and a noise signal in each relay node existing on a plurality of communication paths connectable between the source node and the destination node; and determining one communication path satisfying the determined optimal number of hops from among the plurality of communication paths.

### CROSS-REFERENCE TO RELATED APPLICATIONS

This is a continuation of International Application No. PCT/KR2012/000647, filed on Jan. 30, 2012, which claims priority to Korean Application No.: 10-2011-0050797 filed on May 27, 2011, which applications are incorporated herein by reference.

### TECHNICAL FIELD

The present invention relates to a relay-based communication system and a method for determining a communication path. More particularly, the present invention relates to a system and method for determining the optimal number of hops when transmitting information over a relay network.

### BACKGROUND ART

Wireless Sensor Network (WSN) technology, a technology for forming a network by wirelessly connecting sensor devices, has realized a ubiquitous environment that enables information sharing not only between people and things but also between things anywhere anytime by expanding the people-oriented information management. As for the WSN, its commercialization is underway in a variety of industries due to the changes in the environment such as continued growth of the Internet, development of low-cost sensors, and international standards. The WSN may provide a variety of information for the convenience of our lives and for applications of science and technology by performing the ability to detect information through sensors and to process the detected information.

Wireless personal area networks in the WSN relate to relay-based communication, and the relay-based communication is scheduled to be definitely included in the 4^{th} Generation (4G) or 5^{th} Generation (5G) communication-related standards in the future.

Transmission in each time slot during relay transmission is called ‘hop’, and a relay transmission protocol may classify the relay transmission into dual-hop relay transmission and multi-hop relay transmission depending on the number of hops during transmission. The dual-hop relay transmission refers to transmitting information over two hops, and in this transmission, a relay node may receive information from a source node and transmit the received information to a destination node.

On the other hand, the multi-hop relay transmission refers to transmitting information over multiple hops when a source node transmits information to a destination node. In the multi-hop relay transmission, the first relay node may receive information from the source node; the following relay nodes may transmit the information to each other; and the last relay node may transmit the information to the destination node. The multi-hop relay transmission is greater than the dual-hop relay transmission in terms of the number of hops, but may reduce the error probability since it transmits information multiple times within a short distance.

However, in the conventional relay transmission, interference signals and noise signals, which may occur in relay nodes, are not taken into consideration, and the multi-hop relay transmission may transmit information over multiple hops because of the attenuation which may occur in long-distance communication, but it is inefficient to use too many hops.

### SUMMARY

An aspect of the present invention is to provide a relay-based communication system and communication path determination method for determining the optimal number of hops during relay transmission.

Another aspect of the present invention is to provide a relay-based communication system and communication path determination method for determining the number of hops taking into account interference signals and noise signals.

Further another aspect of the present invention is to provide a relay-based communication system and communication path determination method for determining the number of hops taking into account the distance and path loss between a source node and a destination node.

In accordance with an aspect of the present invention, there is provided a method for determining a communication path through which at least one of a source node, a destination node, and at least one relay node between the source node and the destination node transmits information between the source node and the destination node in a relay network.

In accordance with an exemplary embodiment of the present invention, there is provided a method for determining a communication path through which at least one of a source node, a destination node, and at least one relay node between the source node and the destination node transmits information between the source node and the destination node in a relay network, the method including determining the optimal number of hops taking into account an interference signal and a noise signal in each relay node existing on a plurality of communication paths connectable between the source node and the destination node; and determining one communication path satisfying the determined optimal number of hops from among the plurality of communication paths.

The determining of the optimal number of hops may include determining the optimal number of hops taking further into account a distance between the source node and the destination node and a path loss between the source node and the destination node.

The interference signal may be identified using at least one of a distribution rate of nodes acting as an interference signal per unit area, a radius of a region acting as an interference signal, transmission power of a node acting as an interference signal, transmission power of each relay node, a distance between the source node and the destination node, a path loss index between the source node and the destination node, and the number of bits transmitted to each relay node.

The noise signal may be identified using at least one of a distance between the source node and the destination node, noise distribution over receivers in relay nodes corresponding to the number of hops, which is determined by the source node, a path loss index between the source node and the destination node, the number of bits transmitted to each relay node, and transmission power of each relay node.

The optimal number of hops may be determined by identifying a phase value using the interference signal and the noise signal, and by using the identified phase value.

The optimal number of hops may be determined by the source node.

In accordance with another aspect of the present invention, there is provided a relay-based communication system for transmitting information between a source node and a destination node in a relay network.

In accordance with another exemplary embodiment of the present invention, there is provided a relay-based communication system for transmitting information between a source node and a destination node in a relay network, the system including at least one node for determining the optimal number of hops taking into account an interference signal and a noise signal in each relay node existing on a plurality of communication paths connectable between the source node and the destination node, and determining one communication path satisfying the determined optimal number of hops from among the plurality of communication paths. The at least one node may be at least one of the source node, the destination node, and at least one relay node existing between the source node and the destination node.

The at least one node for determining one communication path may be the source node, and the source node may determine the optimal number of hops taking further into account a distance between the source node and the destination node and a path loss between the source node and the destination node.

The source node may include an input unit for receiving a distance between the source node and the destination node, and a path loss index between the source node and the destination node; an identification unit for identifying an interference signal and a noise signal using the distance between the source node and the destination node, and the path loss index between the source node and the destination node; and a determination unit for determining the optimal number of hops used for forming a communication path between the source node and the destination node, taking into account the interference signal and noise signal identified by the identification unit.

The interference signal may be identified using at least one of a distribution rate of nodes acting as an interference signal per unit area, a radius of a region acting as an interference signal, transmission power of a node acting as an interference signal, transmission power of each relay node, a distance between the source node and the destination node, a path loss index between the source node and the destination node, and the number of bits transmitted to each relay node, and the noise signal may be identified using at least one of a distance between the source node and the destination node, noise distribution over receivers in relay nodes corresponding to the number of hops, which is determined by the source node, a path loss index between the source node and the destination node, the number of bits transmitted to each relay node, and transmission power of each relay node.

The source node may determine the optimal number of hops by identifying a phase value using the interference signal and the noise signal, and by using the identified phase value.

The relay-based communication system and communication path determination method according to an exemplary embodiment of the present invention may efficiently transmit information by determining the optimal number of hops during relay transmission.

Further, the relay-based communication system and communication path determination method according to an exemplary embodiment of the present invention may determine the number of hops taking into account interference signals and noise signals in order to assume the system model that is suitable for the actual sensor or Ad-hoc network.

Besides, the relay-based communication system and communication path determination method according to an exemplary embodiment of the present invention may determine the number of hops taking into account the distance and path loss between the source node and the destination node.

### BRIEF DESCRIPTION OF DRAWINGS

FIG. 1 illustrates a configuration of a relay-based communication system according to an exemplary embodiment of the present invention.

FIG. 2 is a block diagram illustrating a source node in a relay-based communication system according to an exemplary embodiment of the present invention.

FIG. 3 is a flowchart illustrating a method for determining a communication path according to an exemplary embodiment of the present invention.

FIG. 4 illustrates the distribution of nodes in a relay-based communication system according to an exemplary embodiment of the present invention.

FIG. 5 is a graph illustrating a difference between multi-hop relay and dual-hop relay in a relay-based communication system according to an exemplary embodiment of the present invention.

FIG. 6 is a graph illustrating a difference in the number of hops in a relay-based communication system according to an exemplary embodiment of the present invention.

FIG. 7 is a flowchart illustrating a method for transmitting information in a relay-based communication system according to an exemplary embodiment of the present invention.

### DETAILED DESCRIPTION

Reference will now be made to the accompanying drawings to describe in detail the principle of an operation of a relay-based communication system and communication path determination method according to an exemplary embodiment of the present invention. The following description will be made with reference to the drawings merely as one of several ways to effectively describe the features of the present invention, and the present invention will not be limited to the accompanying drawings and the following description. In addition, descriptions of well-known functions and constructions may be omitted for clarity and conciseness. The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

Although the terms will be properly modified or combined, or used in separation for those skilled in the art to clearly understand them, in order to efficiently describe the key technical features of the present invention, this is not to limit the scope of the present invention.

A detailed description will be made of a way to determine the number of hops used for forming a communication path between a source node and a destination node, taking into account interference signals and noise signals in nodes distributed over a relay-based communication system according to an exemplary embodiment of the present invention.

An exemplary embodiment of the present invention will now be described in detail below with reference to the accompanying drawings.

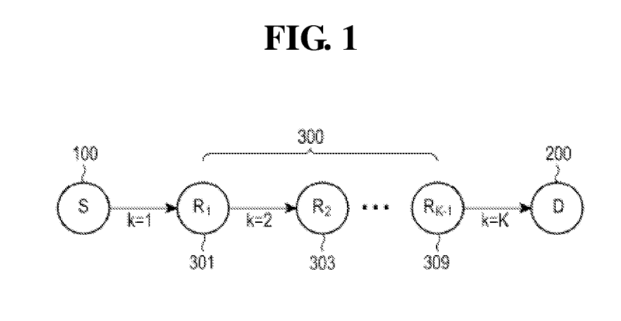

FIG. 1 illustrates a configuration of a relay-based communication system according to an exemplary embodiment of the present invention.

Referring to FIG. 1, a relay-based communication system may include a source node 100, a destination node 200, and a plurality of relay nodes 301, 303 and 309. Unless stated otherwise, the plurality of relay nodes 301, 303 and 309 will be referred to as ‘relay nodes 300’.

The relay-based communication system may transmit information using a communication protocol that is based on the Decode-and-Forward (DF) technique.

In order to transmit its own information to the destination node 200, the source node 100 may transmit the information to the relay nodes 300 adjacent to the source node 100.

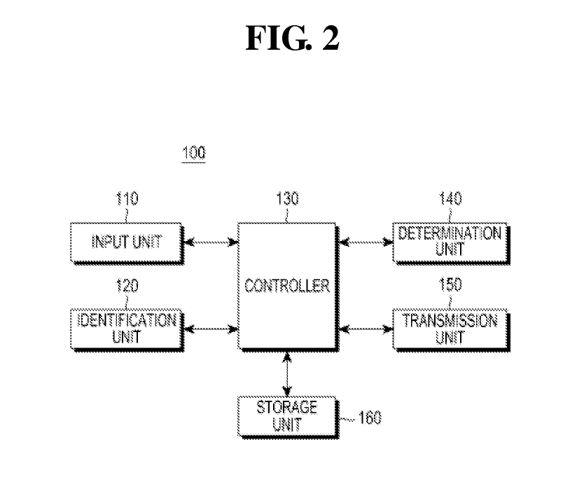

The source node 100 may determine a communication path through which at least one of the relay nodes 300 between the source node 100 and the destination node 200 transmits information between the source node 100 and the destination node 200. Specifically, the source node 100 may determine the number of hops used for forming a communication path between the source node 100 and the destination node 200, taking into account interference signals and noise signals in nodes distributed over the relay-based communication system. The source node 100 will be described in more detail with reference to FIG. 2.

The relay nodes 300 may receive information from the source node 100, and transmit the received information to their adjacent relay nodes 300 or the destination node 200. Specifically, the relay nodes 300 may decode the information received from the source node 100, encode the decoded information again, and transmit the encoded information to the destination node 200. For example, the first relay node 301 may receive information from the source node 100, and transmit the received information to the second relay node 303. The second relay node 303 may receive information from the first relay node 301, and transmit the received information to the third relay node. A (k−1)-th relay node 309, which is adjacent to the destination node 200, may receive information from a (k−2)-th relay node, and transmit the received information to the destination node 200. In this case, k may be the same as the number of hops, which is determined by the source node 100. In other words, the relay nodes 300 may be configured or determined depending on the number of hops, which is determined by the source node 100. The distance between the multiple relay nodes 300 may be constant.

The destination node 200 may receive information from the source node 100 via the plurality of relay nodes 300. For example, the destination node 200 may receive information from the (k−1)-th relay node 309. The destination node 200 may decode the information received from the relay nodes 300 and combine the decoded information, thereby obtaining desired information.

FIG. 2 is a block diagram illustrating a source node in a relay-based communication system according to an exemplary embodiment of the present invention.

Referring to FIG. 2, the source node 100 may include an input unit 110, an identification unit 120, a controller 130, a determination unit 140, a transmission unit 150, and a storage unit 160.

The input unit 110 may receive, from a user, information needed to identify interference signals and noise signals. For example, the input unit 110 may receive, from the user, information needed to identify interference signals and noise signals, such as the distribution rate of nodes acting as an interference signal per unit area, the radius of a region acting as an interference signal, the transmission power of a node acting as an interference signal, the transmission power of each relay node 300, the distance between the source node 100 and the destination node 200, the path loss index between the source node 100 and the destination node 200, the number of bits transmitted to each relay node 300, and the noise distribution over receivers in the relay nodes 300 corresponding to the number of hops, which is determined by the source node 100.

Although it is assumed herein that the input unit 110 receives, from the user, information needed to identify interference signals and noise signals, the present invention will not be limited thereto. For example, the input unit 110 may receive information needed to identify interference signals and noise signals, from an external device (not shown) that stores or manages the information needed to identify interference signals and noise signals, through a communication unit (not shown) or a separate interface (not shown).

The identification unit 120 may identify interference signals and noise signals acting as interferences and noises in the relay-based communication system. Specifically, the identification unit 120 may identify interference signals using at least one of the distribution rate of nodes acting as an interference signal per unit area, the radius of a region acting as an interference signal, the transmission power of a node acting as an interference signal, the transmission power of each relay node 300, the distance between the source node 100 and the destination node 200, the path loss index between the source node 100 and the destination node 200, and the number of bits transmitted to each relay node 300.

In addition, the identification unit 120 may identify noise signals using at least one of the distance between the source node 100 and the destination node 200, the noise distribution over receivers in the relay nodes 300 corresponding to the number of hops, which is determined by the source node 100, the path loss index between the source node 100 and the destination node 200, the number of bits transmitted to each relay node 300, and the transmission power of each relay node 300.

The controller 130 may control the overall operation of the source node 100. Specifically, the controller 130 may control the input unit 110, the identification unit 120, the determination unit 140, the transmission unit 150 and the storage unit 160, which are components of the source node 100. For example, if information needed to identify interference signals and noise signals is received through the input unit 110, the controller 130 may control the identification unit 120 to identify interference signals and noise signals using the information received via the input unit 110. In addition, the controller 130 may control the storage unit 160 to store data in the storage unit 160. The controller 130 may generate information to be transmitted to the destination node 200. The information to be transmitted to the destination node 200 may be generated using information received from the user, or generated using information stored in advance in the storage unit 160. The information to be transmitted to the destination node 200 may also be received from the outside. The controller 130 may control the transmission unit 150 to transmit information to the relay nodes 300.

The determination unit 140 may determine the optimal number of hops taking into account interference signals and noise signals. Specifically, the determination unit 140 may receive interference signals and noise signals from the identification unit 120. The determination unit 140 may determine the number of hops by identifying a phase value using the interference signals and noise signals, and by using the identified phase value.

The transmission unit 150 may transmit information to be transmitted to the destination node 200, to the adjacent relay nodes 300. For example, the transmission unit 150 may transmit information to the first relay node 301, which is adjacent to the source node 100.

The storage unit 160 may store various programs for controlling the overall operation of the source node 100, and may also store various data generated by the execution of the programs, and the data obtained. For example, the storage unit 160 may store information received via the input unit 110. The storage unit 160 may store the interference signals and noise signals identified by the identification unit 120. The storage unit 160 may store the number of hops, which is determined by the determination unit 140. The storage unit 160 may store the information transmitted via the transmission unit 150.

The storage unit 160 may provide the necessary data at the request of the input unit 110, the identification unit 120, the controller 130, the determination unit 140, and the transmission unit 150. The storage unit 160 may include an integrated memory, or a plurality of divided memories. For example, the storage unit 160 may include a Read Only Memory (ROM), a Random Access Memory (RAM), a flash memory, and the like.

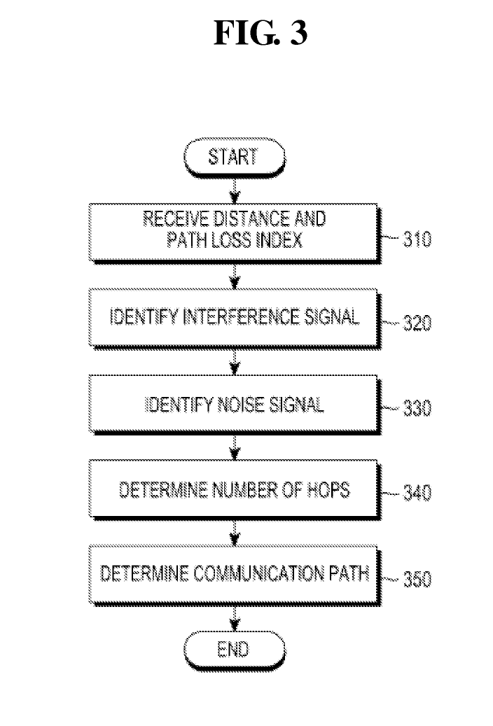

FIG. 3 is a flowchart illustrating a method for determining a communication path according to an exemplary embodiment of the present invention. Prior to this, the structures of the source node 100 according to an exemplary embodiment of the present invention, which has been described with reference to FIG. 2, may be integrated or subdivided, so it should be noted that the components implementing the aforesaid functions may correspond to the structures of the source node 100 according to an exemplary embodiment of the present invention, regardless of their names. Therefore, in describing the proposed method for determining the number of relay nodes 300 by the source node 100, the source node 100 other than the relevant component will be assumed as the entity of each phase.

Referring to FIG. 3, the source node 100 may receive, from the user, information needed to identify interference signals and noise signals, such as the distance and path loss index between the source node 100 and the destination node 200 (310). Specifically, the source node 100 may receive information needed to identify interference signals and noise signals, such as the noise distribution over receivers in the relay nodes 300 corresponding to the number of hops, which is determined by the source node 100. The source node 100 may further receive the distribution rate of nodes acting as an interference signal per unit area, the radius of a region acting as an interference signal, the transmission power of a node acting as an interference signal, the transmission power of each relay node 300, and the number of bits transmitted to each relay node 300.

The source node 100 may identify interference signals using the received information (320). Specifically, the source node 100 may identify interference signals using at least one of the distribution rate of nodes acting as an interference signal per unit area, the radius of a region acting as an interference signal, the transmission power of a node acting as an interference signal, the transmission power of each relay node 300, the distance between the source node 100 and the destination node 200, the path loss index between the source node 100 and the destination node 200, and the number of bits transmitted to each relay node 300.

The source node 100 may identify noise signals using the received information (330). Specifically, the source node 100 may identify noise signals using at least one of the distance between the source node 100 and the destination node 200, the noise distribution over receivers in the relay nodes 300 corresponding to the number of hops, which is determined by the source node 100, the path loss index between the source node 100 and the destination node 200, and the number of bits transmitted to each relay node 300.

The source node 100 may determine the number of hops taking into account interference signals and noise signals in the relay nodes 300 exiting in a plurality of communication paths connectable between the source node 100 and the destination node 200 (340). In other words, the source node 100 may generate calculated values by calculating interference signals and noise signals, and determine the optimal number of hops using phase values of the calculated values.

The source node 100 may determine one communication path satisfying the determined optimal number of hops from among the plurality of communication paths (350).

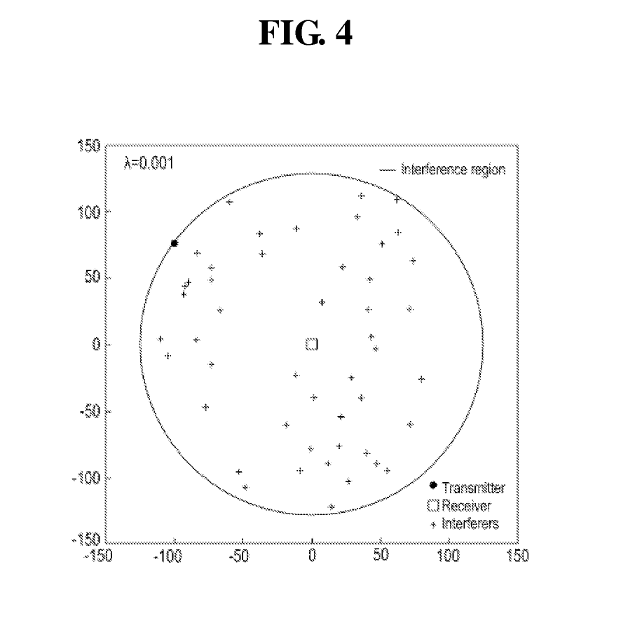

The method for determining the number of hops according to an exemplary embodiment of the present invention will be described in detail with reference to FIGS. 4 to 6.

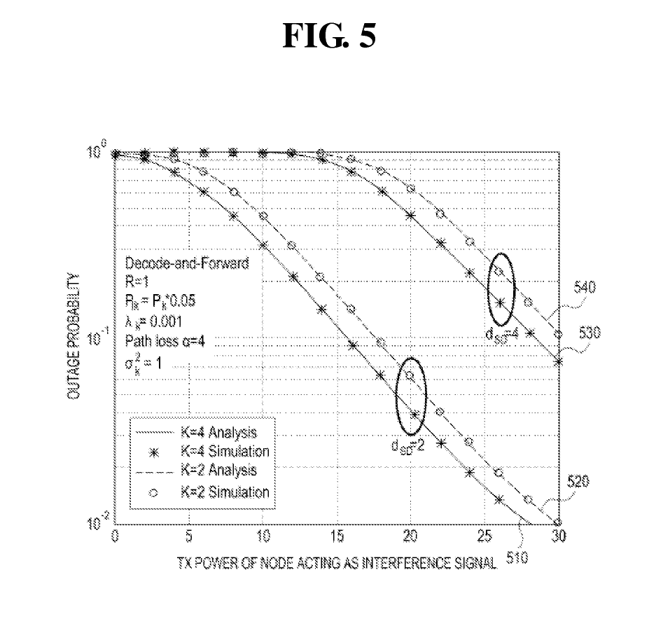

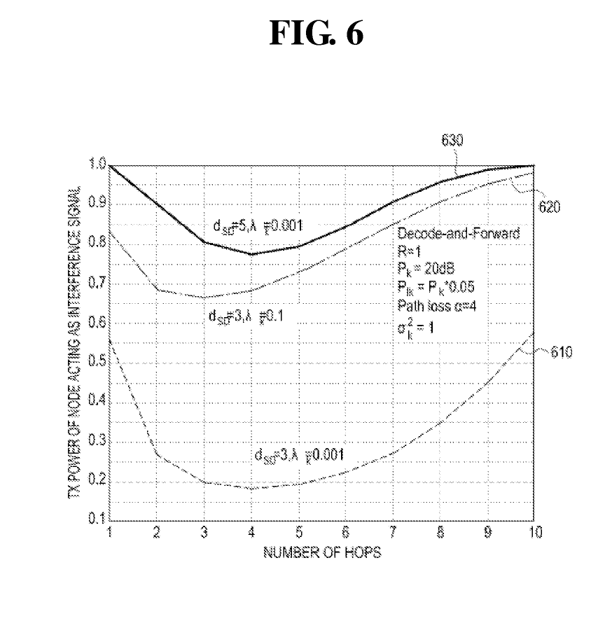

FIG. 4 illustrates the distribution of nodes in a relay-based communication system according to an exemplary embodiment of the present invention, FIG. 5 is a graph illustrating a difference between multi-hop relay and dual-hop relay in a relay-based communication system according to an exemplary embodiment of the present invention, and FIG. 6 is a graph illustrating a difference in the number of hops in a relay-based communication system according to an exemplary embodiment of the present invention.

The method for determining the number of hops according to an exemplary embodiment of the present invention will be assumed to be performed in a relay-based communication system that is based on liner multi-relay nodes 300 as illustrated in FIG. 1. This communication system may include one source node 100, one destination node 200, and (K−1) relay nodes 300. It will be assumed that each relay node 300 decodes only the signal received from its preceding relay node 300, and each relay node 300 does not broadcast its signal.

Relay transmission of multi-relay nodes 300 may include multiple transmissions of a single-relay node 300. As illustrated in FIG. 4, all nodes are shown in transmission of any single-relay node 300. In the transmission of a single-relay node 300 may be involved one source node 100 and one destination node 200, and nodes generating interference signals may be randomly distributed, and their positions may be determined in accordance with the Poisson distribution.

Transmission of each single-relay node 300 may be made in the form of FIG. 4, and if transmission is made using a single-relay node 300, it will be called relay of multi-relay nodes 300. The reason why the present invention uses relay of multi-relay nodes 300 instead of using relay of dual-relay nodes 300 will be described using FIG. 5. As illustrated in FIG. 5, simulations were performed on the assumption that the number (R) of bits to be transmitted to each relay node 300 is 1, the transmission power (P_{IK}) of a node acting as an interference signal is a value obtained by multiplying the transmission power (Pₖ) of each relay node 300 by 0.05, the distribution rate (λₖ) of nodes acting as an interference signal per unit area is 0.001, the path loss index (a) is 4, and the noise distribution (σ²ₖ) over receivers in the relay nodes 300 is 1. As illustrated in FIG. 5, it can be appreciated that if the distance (d_{SD}) between the source node 100 and the destination node 200 is 2, relay 510 of multi-relay nodes 300 is better in performance than relay 520 of dual-relay nodes 300. It can also be understood that even if the distance (d_{SD}) between the source node 100 and the destination node 200 is 4, relay 530 of multi-relay nodes 300 is better in performance than relay 540 of dual-relay nodes 300. The reason why the relay of dual-relay nodes 300 is worse in performance than the relay of multi-relay nodes 300 is that if long-distance transmission is performed over two relay nodes 300, the performance may be reduced due to the path loss. In other words, the reason why the present invention uses the relay of multi-relay nodes 300 instead of using the relay of dual-relay nodes 300 is because multiple short-distance transmissions may contribute to the better performance.

In order to determine the number of hops according to the present invention, each relay node 300 is assumed to transmit information using the DF technique. Accordingly, if the final Signal-to-Interference plus Noise Ratio (SINR) for DF relay of multi-relay nodes 300 may be determined as the minimum value of SINR of each relay node 300, it may be defined as in Equation (1) below.

[Equation 1]

$${γ}_{eq} = {min}_{k = 1 , 2 , … , K} {γ}_{k}$$

where γₖ denotes SINR of each relay node 300, and K denotes the number of relay nodes 300.

Using Equation (1), the outage probability of DF relay of multi-relay node 300 may be defined as in Equation (2) below.

$${P}_{out} ( R ) = 1 - exp [ - {\sum }_{k = 1}^{K} ( \frac{{d}_{k}^{a} {σ}_{k}^{2}}{{P}_{k}} ( {2}^{KR - 1} ) + \frac{{π}^{2} {λ}_{k} erf ( \sqrt{{r}_{k}} )}{2} \sqrt{\frac{{d}_{k}^{a} {P}_{lk} ( {2}^{KR} - 1 )}{{P}_{k}}} ) ] \qquad [ Equation 2 ]$$

where dₖ denotes a distance between relay nodes 300, ‘a’ denotes a path loss index, Pₖ denotes transmission power of each relay node 300, K denotes the number of hops used for forming a communication path between the source node 100 and the destination node 200, σₖ denotes noise distribution over receivers in relay nodes 300, λₖ denotes distribution rate (or the number of nodes) of nodes acting as an interference signal per unit area, rₖ denotes a radius of a region acting as an interference signal, R denotes the number (bps/Hz) of bits to be transmitted to each relay node 300, and P_{IK} denotes transmission power of a node acting as an interference signal.

Using Equation (2), the optimal number of hops, which minimizes the outage probability may be determined. In order to determine the optimal number of hops, it will be assumed that system parameters in transmission of relay nodes 300 are all the same, and the distances between relay nodes 300 are all the same. The number of hops may be defined as in Equation (3) below.

$${K}_{opt} = arg min ( \frac{{d}_{SD}^{a} {σ}_{k}^{2}}{{P}_{k}} {K}^{1 - a} ( {2}^{KR} - 1 ) + \frac{{π}^{2} {λ}_{k} erf ( \sqrt{{r}_{k}} ) \sqrt{{P}_{lk}} {d}_{SD}^{a / 2}}{2 \sqrt{{P}_{k}}} \sqrt{{2}^{KR} - 1} ) \qquad [ Equation 3 ]$$

where D_{SD} denotes a distance between the source node 100 and the destination node 200, ‘a’ denotes a path loss index, K denotes the number of hops used for forming a communication path between the source node 100 and the destination node 200, σₖ denotes noise distribution over receivers in relay nodes 300, λₖ denotes distribution rate (or the number of nodes) of nodes acting as an interference signal per unit area, R denotes the number (bps/Hz) of bits to be transmitted to each relay node 300, and P_{IK} denotes transmission power of a node acting as an interference signal.

In addition,

$$\frac{{d}_{SD}^{a} {σ}_{k}^{2}}{{P}_{k}} {K}^{1 - a} ( {2}^{KR} - 1 )$$

may denote a noise signal, and

$$\frac{{π}^{2} {λ}_{k} erf ( \sqrt{{r}_{k}} ) \sqrt{{P}_{lk}} {d}_{SD}^{a / 2}}{2 \sqrt{{P}_{k}}} \sqrt{{2}^{KR} - 1}$$

may denote an interference signal.

The number of hops may be different depending on the transmission power (P_{IK}) of a node acting as an interference signal and the transmission power (Pₖ) of each relay node 300.

According to a first exemplary embodiment, the transmission power (P_{IK}) of a node acting as an interference signal will be assumed to be determined at a specific ratio β of the transmission power (Pₖ) of each relay node 300 as shown in Equation (4).

Pₗₖ=Pₖ×β [Equation 4]

where P_{IK} denotes transmission power of a node acting as an interference signal, Pₖ denotes transmission power of each relay node 300, and β denotes a specific ratio.

Therefore, the source node 100 may identify noise signals by substituting the distance between the source node 100 and the destination node 200 for d_{SD}, substituting the path loss index for ‘a’, substituting the noise distribution over receivers in relay nodes 300 for σₖ, substituting the number (bps/Hz) of bits to be transmitted to each relay node 300 for R, and substituting the transmission power of each relay node 300 for P_{K} in Equation (3). In addition, the source node 100 may identify interference signals by substituting the distribution rate (or the number of nodes) of nodes acting as an interference signal per unit area for λₖ, substituting the radius of a region acting as an interference signal for rₖ, substituting the transmission power of a node acting as an interference signal for P_{IK}, substituting the distance between the source node 100 and the destination node 200 for d_{SD}, substituting the number (bps/Hz) of bits to be transmitted to each relay node 300 for R, and substituting the transmission power of each relay node 300 for P_{K} in Equation (3). Thereafter, the source node 100 may generate calculated values by adding the noise signals to the interference signals as shown in Equation (3), and determine the number of hops using the minimum values at phase values of the calculated values.

The number of hops may be defined again as in Equation (5).

$$\frac{3}{( x + 1 ) ln 2} < R < \frac{3}{x ln 2} \to {K}_{opt} \leq x \qquad [ Equation 5 ]$$

where K denotes the number of hops used for forming a communication path between the source node 100 and the destination node 200, R denotes the number of bits to be transmitted to each relay node 300, and x is a natural number. If a natural number is substituted for x in Equation (5), Table 1 below may be given.

TABLE 1

| Number (R) of bits to be transmitted by hop | Number (K) of hops |
|---|---|
| 0.72 < R < 0.86 | K <= 6 |
| 0.86 < R < 1.08 | K <= 5 |
| 1.08 < R < 1.44 | K <= 4 |
| 1.44 < R < 2.16 | K <= 3 |
| 2.16 < R < 4.3 | K <= 2 |
| 4.3 < R | K <= 1 |

Accordingly, as illustrated in Table 1, the number of hops may be different depending on the number bits to be transmitted to each relay node 300. For example, the number of hops may be a natural number less than or equal to 6, as illustrated in Table 1. The number of hops may be a value between 1 and 6 depending on the system parameters.

For example, if the number (R) of bits to be transmitted to each relay node 300 is 1, the number (K) of hops may be less than or equal to 5. Even for the number of hops, simulations were performed on the assumption that the graph illustrated in FIG. 6 is based on the DF relay technique, the number (R) of bits to be transmitted to each relay node 300 is 1, the transmission power (Pₖ) of each relay node 300 is 20 dB, the transmission power (P_{IK}) of a node acting as an interference signal is a value obtained by multiplying the transmission power (Pₖ) of each relay node 300 by 0.05, the path loss index (a) is 4, and the noise distribution (σ²ₖ) over receivers in the relay nodes 300 is 1. As illustrated in FIG. 6, it can be appreciated that in the case where the distance (d_{SD}) between the source node 100 and the destination node 200 is 3 and the distribution rate (λₖ) of nodes acting as an interference signal per unit area is 0.001, the best performance may be given if the number (K) of hops is 4. In addition, it can be understood that in the case where the distance (d_{SD}) between the source node 100 and the destination node 200 is 3 and the distribution rate (λₖ) of nodes acting as an interference signal per unit area is 0.1, the best performance may be given if the number (K) of hops is 3. It is also noted that in the case where the distance (d_{SD}) between the source node 100 and the destination node 200 is 5 and the distribution rate (λₖ) of nodes acting as an interference signal per unit area is 0.001, the best performance may be given if the number (K) of hops is 4. In other words, it is preferable for the number of hops to be less than or equal to 5, because performance degradation may occur if the number of hops exceeds 5.

According to a second exemplary embodiment, if the transmission power (P_{IK}) of a node acting as an interference signal and the transmission power (Pₖ) of each relay node 300 are assumed to be independent of each other, the minimum value of the number of hops may be defined as in Equation (6).

$$\frac{2 + W ( - \frac{2}{{e}^{2}} )}{( x + 1 ) ln 2} < R < \frac{2 + W ( - \frac{2}{{e}^{2}} )}{x ln 2} = > {K}_{opt} \geq x \qquad [ Equation 6 ]$$

In addition, the maximum value of the number of hops may be defined as in Equation (7).

$$\frac{3 + W ( - \frac{3}{{e}^{3}} )}{x ln 2} < R < \frac{3 + W ( - \frac{3}{{e}^{3}} )}{( x - 1 ) ln 2} = > {K}_{opt} \leq x \qquad [ Equation 7 ]$$

In Equations (6) and (7), K denotes the number of hops used for forming a communication path between the source node 100 and the destination node 200, R denotes the number of bits to be transmitted to each relay node 300, x is a natural number. In addition, W denotes a Lambert W function.

Based on Equations (6) and (7), the number of transmission hops may be defined as in Equation (8).

$${[ \frac{2 + W ( - \frac{2}{{e}^{2}} )}{R ln 2} ]}_{+} \leq {K}_{opt} \leq {[ \frac{3 + W ( - \frac{2}{{e}^{3}} )}{R ln 2} ]}_{+} \qquad [ Equation 8 ]$$

where K denotes the number of hops used for forming a communication path between the source node 100 and the destination node 200, R denotes the number of bits to be transmitted to each relay node 300, x is a natural number. In addition, [ ]₊ denotes the nearest integer. If a natural number is substituted for x in Equation (8), the maximum values of the number (K) of hops may be expressed as in Table 2, and the minimum values of the number (K) of hops may be expressed as in Table 3.

TABLE 2

| Number (R) of bits to be transmitted by | Maximum value of |
|---|---|
| hop | Number (K) of hops |
| 0.41 < R < 0.45 | K <= 10 |
| 0.45 < R < 0.51 | K <= 9 |
| 0.51 < R < 0.58 | K <= 8 |
| 0.58 < R < 0.68 | K <= 7 |
| 0.68 < R < 0.81 | K <= 6 |
| 0.81 < R < 1.02 | K <= 5 |
| 1.02 < R < 1.35 | K <= 4 |
| 1.35 < R < 2.03 | K <= 3 |
| 2.03 < R < 4.07 | K <= 2 |
| 4.07 > R | K = 1 |

TABLE 3

| Number (R) of bits to be transmitted by | Minimum value of |
|---|---|
| hop | Number (K) of hops |
| 0.23 < R | K >= 10 |
| 0.23 < R < 0.25 | K >= 9 |
| 0.25 < R < 0.28 | K >= 8 |
| 0.28 < R < 0.32 | K >= 7 |
| 0.32 < R < 0.38 | K >= 6 |
| 0.38 < R < 0.46 | K >= 5 |
| 0.46 < R < 0.57 | K >= 4 |
| 0.57 < R < 0.76 | K >= 3 |
| 0.76 < R < 1.14 | K >= 2 |
| 1.14 < R < 2.39 | K >= 1 |

Accordingly, the number of hops may be different depending on the number of bits to be transmitted to each relay node as shown in Tables 2 and 3.

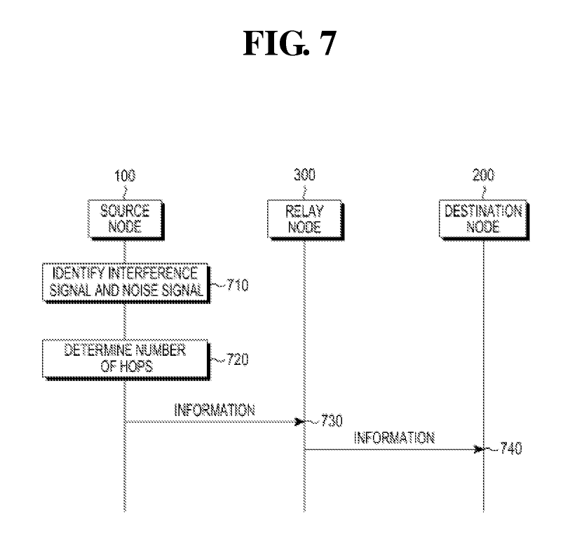

FIG. 7 is a flowchart illustrating a method for transmitting information in a relay-based communication system according to an exemplary embodiment of the present invention.

Referring to FIG. 7, the source node 100 may identify interference signals and noise signals using the distance and path loss index between the source node 100 and the destination node 200 (710).

The source node 100 may determine the number of hops used for forming a communication path between the source node 100 and the destination node 200 using the identified interference signals and noise signals (720).

The source node 100 may transmit information to a relay node 300 (730).

The relay node 300 transmits the information to the destination node 200 (740). In other words, the destination node 200 may receive information through the relay node 300 corresponding to the number of hops, which is determined by the source node 100. For example, if it is assumed that the source node 100 has determined the number of hopes as 3, the source node 100 may transmit information to a first relay node 301 adjacent to the source node 100; the first relay node 301 may transmit the received information to a second relay node 303; the second relay node 303 may transmit the information received from the first relay node 301 to a third relay node (not shown); and the third relay node may transmit the information to the destination node 200. The destination node 200 may receive information from the third relay node.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A method for determining a communication path through which at least one of a source node, a destination node, and at least one relay node between the source node and the destination node transmits information between the source node and the destination node in a relay network, the method comprising:
determining the optimal number of hops taking into account an interference signal and a noise signal in each relay node existing on a plurality of communication paths connectable between the source node and the destination node; and
determining one communication path satisfying the determined optimal number of hops from among the plurality of communication paths.

2. The method of claim 1, wherein the determining of the optimal number of hops comprises determining the optimal number of hops taking further into account a distance between the source node and the destination node and a path loss between the source node and the destination node.

3. The method of claim 1, wherein the interference signal is identified using at least one of a distribution rate of nodes acting as an interference signal per unit area, a radius of a region acting as an interference signal, transmission power of a node acting as an interference signal, transmission power of each relay node, a distance between the source node and the destination node, a path loss index between the source node and the destination node, and the number of bits transmitted to each relay node.

4. The method of claim 1, wherein the noise signal is identified using at least one of a distance between the source node and the destination node, noise distribution over receivers in relay nodes corresponding to the number of hops, which is determined by the source node, a path loss index between the source node and the destination node, the number of bits transmitted to each relay node, and transmission power of each relay node.

5. The method of claim 1, wherein the optimal number of hops is determined by identifying a phase value using the interference signal and the noise signal, and by using the identified phase value.

6. The method of claim 1, wherein the optimal number of hops is determined by the source node.

7. A relay-based communication system for transmitting information between a source node and a destination node in a relay network, the system comprising:
at least one node for determining the optimal number of hops taking into account an interference signal and a noise signal in each relay node existing on a plurality of communication paths connectable between the source node and the destination node, and determining one communication path satisfying the determined optimal number of hops from among the plurality of communication paths;
wherein the at least one node is at least one of the source node, the destination node, and at least one relay node existing between the source node and the destination node.

8. The relay-based communication system of claim 7, wherein the at least one node for determining one communication path is the source node;
wherein the source node determines the optimal number of hops taking further into account a distance between the source node and the destination node and a path loss between the source node and the destination node.

9. The relay-based communication system of claim 8, wherein the source node comprises:
an input unit for receiving a distance between the source node and the destination node, and a path loss index between the source node and the destination node;
an identification unit for identifying an interference signal and a noise signal using the distance between the source node and the destination node, and the path loss index between the source node and the destination node; and
a determination unit for determining the optimal number of hops used for forming a communication path between the source node and the destination node, taking into account the interference signal and noise signal identified by the identification unit.

10. The relay-based communication system of claim 7, wherein the interference signal is identified using at least one of a distribution rate of nodes acting as an interference signal per unit area, a radius of a region acting as an interference signal, transmission power of a node acting as an interference signal, transmission power of each relay node, a distance between the source node and the destination node, a path loss index between the source node and the destination node, and the number of bits transmitted to each relay node;
wherein the noise signal is identified using at least one of a distance between the source node and the destination node, noise distribution over receivers in relay nodes corresponding to the number of hops, which is determined by the source node, a path loss index between the source node and the destination node, the number of bits transmitted to each relay node, and transmission power of each relay node.

11. The relay-based communication system of claim 8, wherein the source node determines the optimal number of hops by identifying a phase value using the interference signal and the noise signal, and by using the identified phase value.
